(19) United States
(12) Patent Application Publication
(10) Pub. No.: US 2026/0365009 A1
(43) Pub. Date: Nov. 19, 2026

(54) Motor Vehicle

(71) Applicant: Bayerische Motoren Werke Aktiengesellschaft, Muenchen (DE)

(72) Inventors: Ulrich SCHULZ, Muenchen (DE); Thomas SKARDELLY, Ismaning (DE)

(21) Appl. No.: 19/470,872

(22) PCT Filed: Jun. 6, 2024
(86) PCT No.: PCT/EP2024/065514

§ 371 Date: Sep. 30, 2025

(30) Foreign Application Priority Data
Jul. 3, 2023 (DE) 10 2023 117 434.7

(51) Int. Cl. B60K 7/00; B60K 17/16; B60K 17/356

(52) U.S. Cl. CPC B60K 7/0007; B60K 17/16; B60K 17/356; B60K 2007/0046

(57) ABSTRACT

A motor vehicle has at least one drive device which has at least one electric drive machine for driving wheels of the motor vehicle, wherein a rotor of the drive machine is at least partially oriented with its rotational axis in the vehicle longitudinal direction, and wherein the drive device is arranged on a vehicle center axis extending in the vehicle longitudinal direction. A gearbox, which adjoins the drive device in the vehicle longitudinal direction, is positioned between the wheels of a common axle in the vehicle transverse direction.

### BACKGROUND AND SUMMARY

The invention relates to a motor vehicle, in particular to an electrically operatable motor vehicle.

DE 10 2009 057 458 B4 discloses a motor vehicle with a differential subassembly. The motor vehicle furthermore comprises a drive train which comprises a motor and a gearbox. The drive train furthermore comprises a drive shaft, a rear axle subassembly, and a plurality of wheels. The motor is arranged in the longitudinal direction along the axis of the motor vehicle.

DE 11 2008 002 504 B4 furthermore discloses a motor vehicle with an axle subassembly. The motor vehicle moreover comprises a drive train which comprises a motor and a gearbox. The drive train can comprise a transfer box or another force-distribution device, a rear drive shaft, a rear axle subassembly, a plurality of rear wheels, a front drive shaft, a front axle subassembly, and a pair of front wheels. The motor is mounted with a longitudinal orientation along the longitudinal axis of the motor vehicle.

The object of the present invention is to provide a solution which enables a particularly advantageous weight distribution in the motor vehicle.

This object is achieved according to the invention by the subject of the independent claim. Further possible embodiments of the invention are disclosed in the dependent claims, the description, and the figures.

The invention relates to a motor vehicle, in particular to a car, with at least one drive device. The drive device comprises at least one electric drive machine for driving wheels of the motor vehicle. The electric drive machine is configured to utilize electrical energy from a traction battery of the motor vehicle to drive wheels of the motor vehicle, as a result of which the motor vehicle is moved. In particular, the electric drive machine comprises a stator and a rotor which can rotate relative to the stator about an axis of rotation. The rotor of the drive machine is oriented with its axis of rotation at least partially in the vehicle longitudinal direction. It is provided here that, as much as possible, the rotor does not run with its direction of longitudinal extent in the vehicle transverse direction. It is possible that the longitudinal extent of the axis of rotation of the rotor runs at least partially in the vehicle vertical direction. In an alternative embodiment, it is possible that the longitudinal extent of the axis of rotation of the rotor runs entirely in the vehicle longitudinal direction, and the rotor is thus oriented with its axis of rotation parallel to the vehicle longitudinal direction. In other words, it is provided that the axis of rotation of the rotor lies within a plane which is spanned by the vehicle longitudinal direction and the vehicle vertical direction. The axis of rotation of the rotor thus does not run with its direction of longitudinal extent in the vehicle transverse direction.

The drive device is arranged on a vehicle center axis running in the vehicle longitudinal direction. The drive device can here be arranged centrally in the motor vehicle with respect to the vehicle transverse direction. However, it is alternatively possible that the drive device is arranged offset relative to the center of the motor vehicle with respect to the vehicle transverse direction, as long as the drive device is arranged on the vehicle center axis which runs in the vehicle longitudinal direction and is arranged centrally with respect to the vehicle transverse axis, and thus intersects such vehicle center axis. In other words, the drive device is arranged particularly close to a center of the motor vehicle, arranged with respect to the vehicle transverse direction, in particular is arranged centrally with respect to the vehicle transverse direction. As a result, the drive device is arranged particularly close to an overall center of gravity of the motor vehicle. Particularly good driving dynamics of the motor vehicle can consequently be achieved.

It is in particular provided that the at least one drive device, in particular all the drive devices of the motor vehicle, are arranged along the vehicle longitudinal direction between the axles of the motor vehicle and thus between the front axle and the rear axle of the motor vehicle. The axles of the motor vehicle are here defined in particular by an axis of rotation about which the respective wheels of this axle revolve in an undeflected normal position of the wheels. It is in particular provided that the center of gravity of the drive device lies on the centrally running vehicle longitudinal axis of the motor vehicle.

The motor vehicle furthermore comprises a gearbox which is adjacent to the drive device in the vehicle longitudinal direction. The gearbox is furthermore arranged in the vehicle transverse direction between the wheels of a common axle, for example the front axle or the rear axle. The gearbox is here arranged in particular centrally between the wheels of this axle. The gearbox is configured to convert the torque supplied by the drive device individually for the wheels of the common axle. Because the gearbox is arranged between the wheels of the common axle, respective drive shafts running from the gearbox to the wheel hubs of the wheels of this axle can be configured as particularly long in their direction of longitudinal extent. Particularly good transmission of force from the gearbox to the respective wheels of the motor vehicle can consequently be achieved with particularly low loss of power. It is in particular provided that the center of gravity of the gearbox runs on the centrally running vehicle longitudinal axis of the motor vehicle. It is furthermore in particular provided that, because of the central arrangement of the gearbox with respect to the vehicle transverse direction, the drive shafts directly connected to this gearbox are formed with at least substantially the same length in terms of their direction of longitudinal extent.

In one possible development of the invention, it is provided that the drive device rests on an underbody of the motor vehicle. In particular, as a result the rotor is oriented with its axis of rotation at least partially in the vehicle vertical direction. Because the drive device rests on the underbody of the motor vehicle, at least one drive machine of the drive device and/or one inverter of the drive device rests on the underbody of the motor vehicle. Because the drive device rests on the underbody of the motor vehicle, the weight of the drive device is supported at a particularly low point in the motor vehicle, as a result of which a particularly low center of gravity of the motor vehicle can be achieved. In particular, the drive device is arranged as low as possible in the motor vehicle in order to ensure that the overall center of gravity of the motor vehicle is situated particularly low, as a result of which particularly desirable driving properties of the motor vehicle can be achieved.

In a further possible embodiment of the invention, it is provided that the drive device has an electric drive machine for each of the wheels to be driven by means of this drive device. This means that the drive device, where only the wheels of a single axle are to be driven by means of the drive device, comprises two drive machines. The plurality of drive machines of the drive device are arranged in particular in a common housing and are cooled by means of a common cooling circuit. Because the drive device comprises an independent drive machine for each of the wheels to be driven, the wheels of the motor vehicle can be controlled individually particularly precisely. Because the drive machines are arranged in a common housing, the drive device can be designed as particularly compact and with a low weight. The drive machines of the drive device can be cooled particularly efficiently and consequently operated particularly efficiently via the common cooling circuit.

In a further possible embodiment of the invention, it is provided that the gearbox comprises a single-stage bevel gear for each drive machine of the drive device. Bevel gears are a type of gearbox with drive shafts and driven shafts which are situated at an angle to each other and the axes of which have a common point of intersection. The force is transmitted by bevel gear wheels. The bevel gear thus comprises a pair of bevel toothed wheels which mesh with each other. In particular, the bevel gear comprises a bevel pinion and a master gear. In particular, the bevel pinion is arranged on the input side of the bevel gear and the master gear is arranged on the output side of the bevel gear. By means of the single-stage bevel gear, on the one hand a single-stage conversion of the torque supplied by the electric drive machine can be effected and, on the other hand, redirection of the torque at an angle can be effected. It is in particular provided that the torque supplied by the electric drive machine is redirected at a right angle by means of the single-stage bevel gear. As a result, the torque supplied by the rotor oriented with its axis of rotation at least partially in the longitudinal direction can be deflected to the drive shafts which run with their respective directions of longitudinal extent at least in the vehicle transverse direction.

In this connection, it can in particular be provided that the gearbox additionally comprises a planetary gear with a stationary ring gear for each drive machine of the drive device. The planetary gear can here comprise a single-stage or a multi-stage planetary gear set. The planetary gear can also be referred to as an epicyclic gear. This is a toothed-wheel or friction gear which, in addition to shafts fixed to the frame, also has axles which revolve on circular tracks in the frame. Accordingly, a distinction can be made between central or sun gear wheels mounted on the axles fixed to the frame and epicyclic or planetary gear wheels mounted on the revolving axles. An arm which carries the revolving axles rotates for its part about an axle fixed to the frame. The planetary gear has a particularly low volume, as a result of which a particularly large number of transmission stages can be supplied with a particularly low space requirement. The planetary gear furthermore enables high torques to be transmitted because of a plurality of parallel pairs of toothed wheels with a plurality of epicyclic gear wheels. The planetary gear furthermore has a particularly low degree of unbalance. Because the gearbox has the planetary gear in addition to the bevel gear, the gearbox is configured as particularly compact, wherein at the same time a particularly large number of transmission stages can be supplied by means of the gearbox.

In one possible development of the invention, it is provided that, when the drive device comprises just one drive machine by means of which two wheels of the motor vehicle are to be driven, the gearbox additionally comprises a differential. The torque supplied by the drive machine can be allocated individually to the wheels by means of the differential. The differential can also be referred to as a differential gear. The differential is an epicyclic gear with an input and two outputs and thus is a transfer box. The differential allows both wheels to be operated with the same amount of torque, it being possible for the wheels to rotate at different speeds. It is likewise possible that one of the wheels is completely stationary. Different wheel speeds of the wheels can be compensated by means of the differential such that there is no slip and no twisting. The differential thus makes it possible for the drive device to comprise just a single drive machine to drive the two wheels of the same axle and consequently be designed so that it has a particularly low weight.

In a further possible embodiment of the invention, it is provided that the gearbox is connected via a drive shaft to a wheel hub axle of the respective wheel to be driven in a torque-transmitting fashion and the drive shaft is arranged concentrically with the wheel hub axle in the vehicle transverse direction. In other words, the wheel hub axle and the drive shaft associated with this wheel are arranged with their center axes adjacent to each other and thus extending each other. By virtue of the aligned configuration of the drive shafts with the wheel hub axles associated in each case, the torque transmitted to the wheels via the drive shafts can be transmitted to the respective wheel by means of particularly few deflections and consequently with particularly little loss. Transmission of the torque supplied by the respective electric drive machine to the wheels of the motor vehicle can thus be effected with particularly little loss.

In a further possible embodiment of the invention, it is provided that the motor vehicle has a traction battery which is arranged between a front axle and a rear axle of the motor vehicle in the vehicle longitudinal direction. Furthermore, a first drive device by means of which the wheels of the front axle can be driven is provided for the front axle, and a second drive device by means of which the wheels of the rear axle can be driven is provided for the rear axle. In particular, the first drive device and the second drive device are arranged one on top of the other on opposite sides of the traction battery in the vehicle longitudinal direction. This means that the first drive device is arranged in front of the traction battery in the vehicle longitudinal direction and the second drive device is arranged behind the traction battery in the vehicle longitudinal direction. The traction battery is configured to supply the respective drive devices with electrical energy in order to enable driving of the motor vehicle by means of the drive machines of the respective drive device. In particular, the respective drive devices are arranged particularly close to the traction battery in the vehicle longitudinal direction, as a result of which an arrangement of the drive devices particularly close to the center of gravity can be achieved. In particular, the traction battery is arranged in such a way that it is arranged on the vehicle center axis running in the vehicle longitudinal direction and on a vehicle center axis running in the vehicle transverse direction. It is thus provided that the particularly heavy components the traction battery and the drive devices are arranged particularly close to a center of gravity of the motor vehicle, as a result of which particularly good road grip of the motor vehicle can be achieved when driving on a road.

In this connection, it can in particular be provided that the traction battery has at least one recess and at least one of the drive devices projects into the at least one recess. In particular, the recess can be a tunnel of the traction battery running in the longitudinal direction. By virtue of the at least one drive device being arranged in such a way that it at least projects into the tunnel, the drive device can be arranged particularly close to a vehicle center point of the motor vehicle with respect to the vehicle longitudinal direction. This drive device is consequently arranged particularly close to the center of gravity of the motor vehicle. As a result, particularly good driving properties of the motor vehicle can in turn be achieved.

In a further possible embodiment of the invention, it is provided that the traction battery is divided into a plurality of storage blocks and a control device is provided which is configured to regulate from which storage block electrical energy is supplied for which drive device. This means that the respective storage blocks can be adapted in terms of the supply of energy for the respective drive devices. It can thus be regulated by means of the control device by means of which storage blocks electrical energy is supplied for which drive device of the motor vehicle. If, for example, one of the drive devices requires a particularly large amount of electrical energy, it can be regulated by means of the control device that electrical energy is supplied for this drive device from a particularly large number of storage blocks of the traction battery. Switching between the respective storage blocks for supplying energy to the drive devices is thus effected by means of the control device depending on the energy requirement of the respective drive devices. Particularly efficient utilization of the electric power made available by the storage blocks is thus enabled. Particularly high electric power can consequently be called up for driving the motor vehicle.

Further features of the invention can be found in the claims, the figures, and the description of the figures. The features and combinations of features mentioned above in the description, as well as the features and combinations of features shown individually below in the description of the figures and/or in the figures can be used not only in the combination specified in each case but also in other combinations or individually without going beyond the scope of the invention.

### BRIEF DESCRIPTION OF THE DRAWINGS

FIG. 1 shows a schematic side view of a motor vehicle;

FIG. 2 shows a schematic top view of the motor vehicle;

FIG. 3 shows an enlarged schematic illustration of a detail of an axle region of the motor vehicle in a section running in the vehicle longitudinal direction and in the vehicle transverse direction;

FIG. 4 shows an enlarged schematic illustration of a detail of the axle region shown in FIG. 3 in a section running in the vehicle longitudinal direction and in the vehicle vertical direction; and

FIG. 5 shows an enlarged schematic illustration of a detail of the axle region in a section running in the vehicle transverse direction and in the vehicle vertical direction.

The same elements and those with the same function are provided in the Figures with the same reference signs.

### DETAILED DESCRIPTION OF THE DRAWINGS

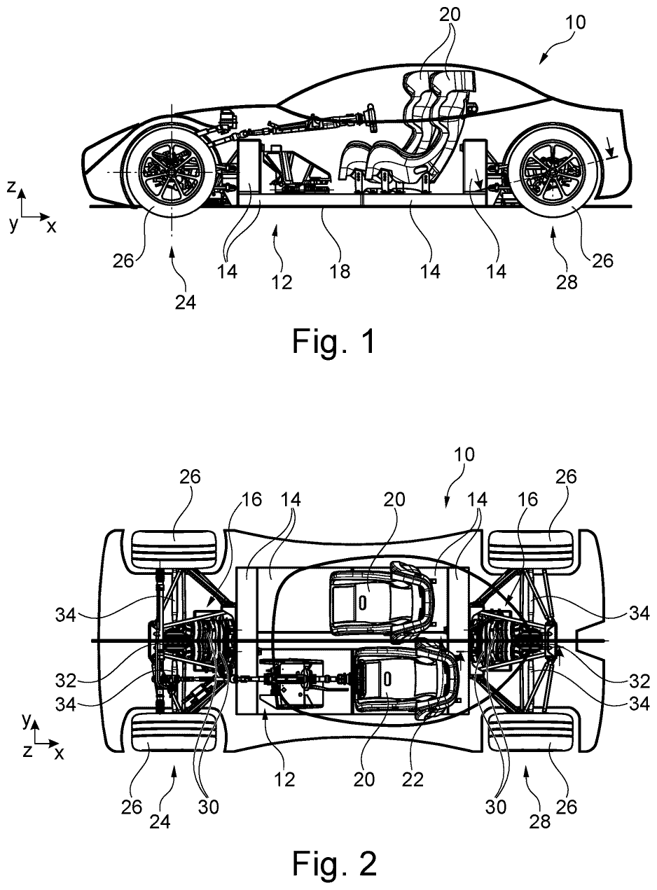

Shown in each case in FIGS. 1 and 2 is a motor vehicle 10 in a side view or in a view from above. In the present case, the motor vehicle 10 is an electrically drivable motor vehicle. The motor vehicle 10 comprises a traction battery 12 which comprises a plurality of storage blocks 14. The traction battery 12 is in particular a so-called high-voltage battery. The traction battery 12 is configured to supply electrical energy for respective drive devices 16 of the motor vehicle 10. In the present case, the motor vehicle 10 comprises two drive devices 16. As can be seen in FIG. 1, the traction battery 12 is arranged so that it rests on an underbody 18 of the motor vehicle 10. In the present case, the traction battery 12 is arranged below respective vehicle seats 20 of the motor vehicle 10. The traction battery 12 has, as can be seen in FIG. 2, an energy tunnel 22 arranged centrally in terms of the vehicle transverse direction y and running with its direction of longitudinal extent in the vehicle longitudinal direction x. This energy tunnel 22 is a tunnel-shaped recess of the traction battery 12. The motor vehicle 10 can comprise a control device (not shown in the Figure) which is configured to control the supply of electrical energy from the respective storage blocks 14 to the drive devices 16. It can be specified by means of the control device from which storage block 14 electrical energy is supplied for which drive device 16. Depending on the power requirement of the respective drive devices 16, the control device can thus initiate or stop the supply of electrical energy to the respective drive device 16 from the respective storage blocks 14. In particular, the control device can assign the respective storage blocks 14 to the respective drive devices 16 in terms of the energy supply.

As can be seen in FIG. 2, the traction battery 12 is arranged centrally in the motor vehicle 10 in terms of the vehicle transverse direction y. Furthermore, in the present case, the traction battery 12 is arranged so that it overlaps a vehicle transverse axis running in the vehicle transverse direction y, wherein this vehicle transverse axis is arranged centrally with respect to the vehicle longitudinal direction x. The traction battery 12 is thus arranged in the motor vehicle 10 in such a way that a vehicle axis running through the center of gravity in the vehicle vertical direction z intersects the traction battery 12. The traction battery 12 is thus arranged particularly close to the center of gravity in terms of the vehicle transverse direction y and the vehicle longitudinal direction x.

As can furthermore be seen particularly clearly in FIG. 2, a first drive device 16 of the two drive devices 16 of the motor vehicle 10 is arranged in front of the traction battery 12 in the vehicle longitudinal direction x, and the second drive device 16 is arranged behind the traction battery 12 in the vehicle longitudinal direction x. The wheels 26 associated with a front axle 24 of the motor vehicle 10 can be driven by means of the first drive device 16. The wheels 26 associated with a rear axle 28 of the motor vehicle 10 can be driven by means of the second drive device 16. In order to enable the drive devices 16 to be arranged particularly close to the center of gravity of the motor vehicle 10, the respective drive devices 16 can project at least in some regions into the energy tunnel 22 of the traction battery 12. In the present case, the first drive device 16 and the second drive device 16 are configured with the same structure and are arranged in the motor vehicle 10 so that they are rotated relative to each other by 180 degrees about the vehicle vertical axis z.

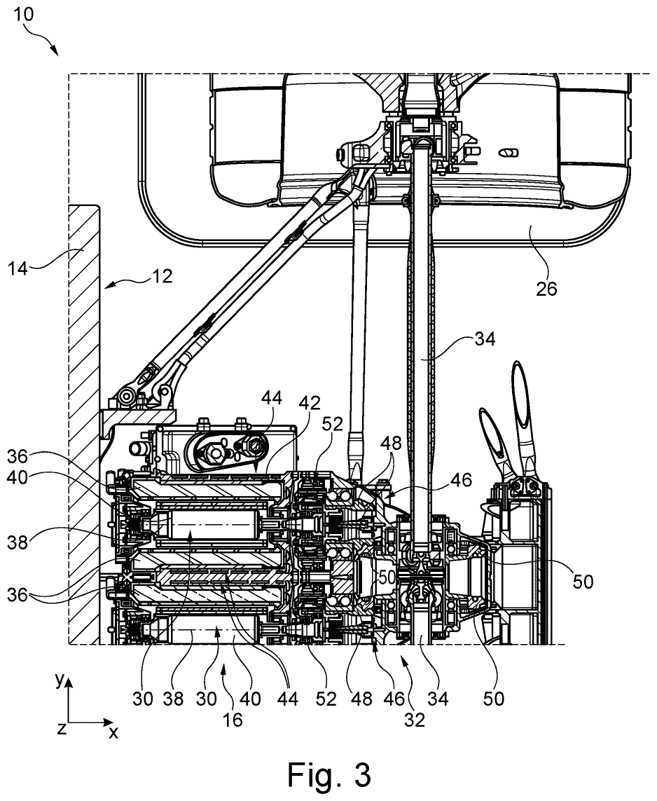

As can be seen particularly well in FIG. 2, each of the drive devices 16 comprises two electric drive machines 30. In the present case, the motor vehicle 10 comprises for each drive device 16 a gearbox 32 which is configured to convert the torque supplied by the respective drive machines 30 and to transmit it to respective drive shafts 34 connected to in each case one wheel 26 in a torque-transmitting fashion. An enlarged detail of one of the drive devices 16 is shown in FIG. 3, wherein the drive device 16 is shown in a cross section running in the vehicle longitudinal direction x and in the vehicle transverse direction y. It can be seen here that the two drive machines 30 of the drive device 16 have in each case a stator 36 and a respective rotor 40 which can rotate relative to the associated stator 36 about an axis of rotation 38. In the present case, the two drive machines 30 of the drive device 16 are oriented parallel to each other with their axes of rotation 38. Each of the axes of rotation 38 here runs at least partially in the vehicle longitudinal direction x, in the present case partially in the vehicle longitudinal direction x and partially in the vehicle vertical direction z. In the present case, it is not provided that the longitudinal extent of the respective axes of rotation 38 has a portion running in the vehicle transverse direction y. In particular, the portion of the longitudinal direction of the axes of rotation 38 running in the vehicle longitudinal direction x is greater than the portion running in the vehicle vertical direction z.

In the present case, the drive devices 16 comprise a common housing 42 in which the two drive machines 30 are accommodated together. By virtue of the electric drive machines 30 being arranged together in the housing 42, the drive machines 30 can be cooled by a common cooling circuit 44.

The configuration of the gearbox 32 can be seen particularly well in FIG. 3. In the present case, the gearbox 32 comprises for each of the drive machines 30 a bevel gear 46 with a bevel pinion 48 and a master gear 50. The bevel pinion 48 is configured to revolve about an axis of rotation which runs parallel to the axis of rotation 38 of the rotor 40 of the associated drive machine 30. In the present case, the respective master gears 50 are configured to rotate about an axis of rotation which in the present case runs perpendicular to the axis of rotation 38 of the rotor 40 of the associated drive machine 30 supplying the torque for this bevel gear 46. The drive shaft 34 connected to this master gear 50 in a torque-transmitting fashion is in turn set in rotation via the master gear 50, as a result of which the wheel 26 associated with this drive shaft 34 is driven. The gearbox 32 furthermore comprises for each of the drive machines 30 a planetary gear 52 which is provided to convert the torque supplied by the rotor 40 of the respective drive machine 30 and supply it for the bevel pinion 48 of the associated bevel gear 46. Each of the planetary gears 52 here has a stationary ring gear. The respective planetary gears 52 can comprise a single-stage or a multi-stage planetary gear set. This means that just a single transmission stage or multiple transmission stages are provided by means of the respective planetary gear 52 depending on the planetary gear set used.

As can be seen particularly well in FIG. 3, it is provided in the present case that neither the drive machines 30 nor the planetary gear 52 nor the bevel pinion 48 of the bevel gear 46 are arranged directly between the two drive shafts 34 of a common axle of the motor vehicle 10 in the vehicle transverse direction y. As a result, respective introduction regions of the drive shafts 34 into which the torque is introduced into the respective drive shaft 34 via the respective master gears 50 can be arranged particularly close to each other in the vehicle transverse direction y. Consequently, the drive shafts 34 can be configured as particularly long, from this introduction region of the torque into the respective drive shaft 34 to respective wheel hubs 60 of the associated wheels 26. The longer the form of the drive shafts 34, the less they are deflected from a design position in the case of maximum compression or rebound of the respective wheels 26 connected to these drive shafts 34. The smaller the deflection of the drive shafts 34, the more efficient the transmission of power is from the gearbox 32 to the respective wheels 26. In the present case, the drive shafts 34 are present with their center axis 56 concentric with respective wheel hub axles 58 of the wheel hubs 60 of the wheels 26 connected to the respective drive shaft 34 in a torque-transmitting fashion.

In the present case, the two drive devices 16 are arranged between the front axle 24 and the rear axle 28 of the motor vehicle 10 and are oriented with the respective axes of rotation 38 of the rotors 40 of the respective drive machines 30 in the vehicle longitudinal direction x. The respective drive devices 16 are thus arranged particularly close to a center of gravity of the motor vehicle 10, as a result of which a particularly good position of the center of gravity of the motor vehicle 10 results. A particularly great length of the drive shafts 34 can furthermore be implemented, as a result of which particularly efficient transmission of power from the respective drive machines 30 to the wheels 26 to be driven by means of these drive machines 30 is made possible.

If it is provided that the respective drive device 16 comprises just one drive machine 30 by means of which two wheels 26 of the motor vehicle 10 are to be driven, then the gearbox 32 associated with this drive device 16 comprises a differential.

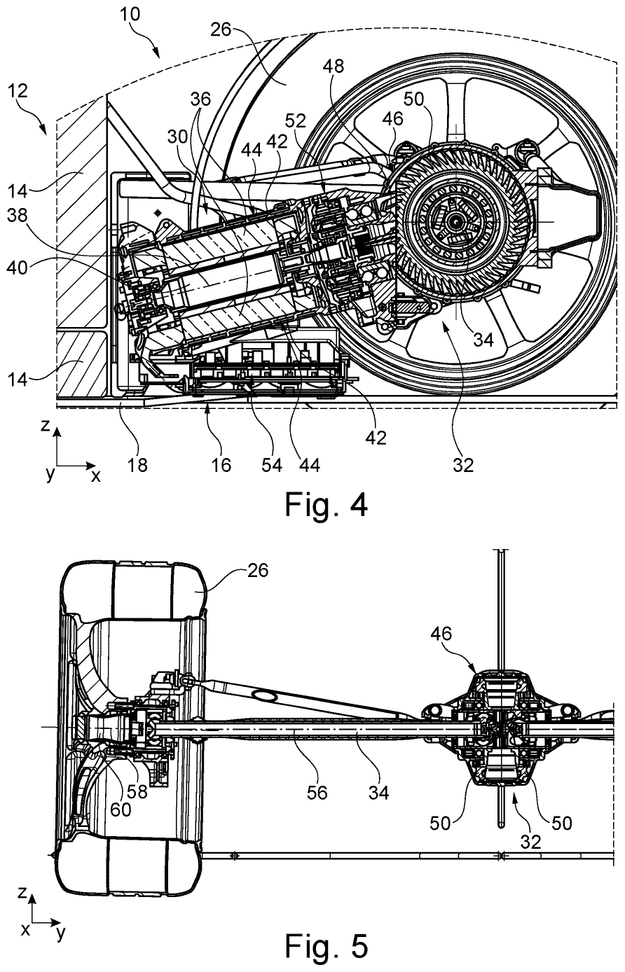

In order to make possible a particularly low center of gravity of the motor vehicle 10, the respective drive devices 16 rest, as can be seen particularly well in FIG. 4, on the underbody 18 of the motor vehicle 10. In the present case, the drive devices 16 comprise one inverter 54 for each drive machine 30, wherein the respective inverters 54 are arranged below, in the vehicle vertical direction z, the respective drive machines 30 with which the respective inverters 54 are associated. The inverter 54 is an electrical device which converts direct current into alternating current. The respective inverter 54 is thus configured to convert direct current from the traction battery 12 into alternating current which the inverter 54 supplies for the associated drive machine 30.

In the present case, the respective drive machines 30 of the drive device 16 are pivoted downward with their ends not connected to the gearbox 32 particularly far in the vehicle transverse direction y, as a result of which the drive device 16 is arranged particularly low in the motor vehicle 10. In an alternative embodiment, the inverter 54 can be arranged next to the respective associated drive machine 30 and thus offset laterally next to the in each case associated drive machine 30 in the vehicle transverse direction y. As a result, it is possible that the respective drive machine 30 is arranged even lower in the motor vehicle 10 and in particular so that it rests on the underbody 18. As a result, the center of gravity of the motor vehicle 10 can thus be arranged as low as possible in the motor vehicle 10.

In the present case, it is provided that the respective drive shafts 34 run, with their center axes 56 running in the direction of longitudinal extent of the respective drive shaft 34, parallel to and concentric with respective wheel hub axles 58, running in the vehicle transverse direction y, of the wheel hubs 60 of the respective associated wheel 26. The respective drive shafts 34 are here oriented with their center axes 56 parallel to the vehicle transverse direction y. In order to achieve a particularly advantageous position of the center of gravity of the motor vehicle 10, it is provided that the respective drive machines 30 are arranged as low as possible in the motor vehicle 10 and in addition the drive shafts 34 and their center axes 56 are oriented as horizontally as possible, in particular parallel to the vehicle transverse direction y.

In an alternative embodiment, the bevel gear 46 can be arranged offset downward relative to the wheel hub axles 58 in the vehicle vertical direction z.

The drive device 16 for the motor vehicle 10 has a particularly compact design and is arranged in the motor vehicle 10 particularly centrally and with a particularly optimal center of gravity, wherein the drive shafts 34 have a particularly great length. The particularly long drive shafts 34 enable a particularly high degree of efficiency of the transmission of force from the gearbox 32 to the wheels 26, a particularly wide range of application, and thus a particularly large deflection of the wheels 26. Because the drive devices 16 are arranged as close as possible to the central longitudinal axis and to the central transverse axis of the motor vehicle 10 with respect to the center of gravity of the motor vehicle 10 and as low as possible in the vertical direction and thus in the vehicle vertical direction z, particularly dynamic driving of the motor vehicle 10 about all possible vehicle axes-a vehicle vertical axis running in the vehicle vertical direction z, a vehicle transverse axis running in the vehicle transverse direction y, and a vehicle longitudinal axis running in the vehicle longitudinal direction x-is made possible.

In the case of the motor vehicle 10, the drive machines 30 are arranged with the respective axes of rotation 38 running in the vehicle longitudinal direction x and as close as possible to the central longitudinal axis of the motor vehicle 10. The axis of rotation 38 can be oriented horizontally or be inclined at a certain angle in the vehicle vertical direction z. With regard to the height at which the drive devices 16 are arranged, they are arranged with at least one point, in particular with their lowest point, resting on the underbody 18 of the motor vehicle 10. The inverter 54 can be arranged compactly on the housing 42, laterally next to the respective associated drive machine 30 or below the respective associated drive machine 30.

In one possible embodiment of the gearbox 32, the latter can comprise just a single gear stage which is supplied by the bevel gear 46. The master gear 50 is here arranged as close as possible to the central longitudinal axis of the motor vehicle 10 in the vehicle transverse direction. Alternatively, the gearbox 32 can, as shown in the Figures, include the planetary gear 52 with the single-stage or multi-stage planetary gear set with a stationary ring gear, and the bevel gear 46 as the second gear stage. The master gear 50 of the bevel gear 46 here also sits as close as possible to the central longitudinal axis of the motor vehicle 10 in the vehicle transverse direction y.

The respective drive shaft 34 can either be flange-mounted directly on the last gear stage of the gearbox 32 or be connected to the last gear stage of the gearbox 32 only via a torsional-vibration damping element as a single intermediate component. If just one drive machine 30 is provided per vehicle axle and thus either for the rear axle 28 or for the front axle 24, a differential is provided between the respective drive shaft 34 and the last gear stage of the gearbox 32. For a given width in the vehicle transverse direction y between the wheel hubs 60 of a common vehicle axle, a particularly great length of the drive shafts 34 can be achieved by virtue of the described arrangement of the last gear stage of the gearbox 32. The last gear stage of the gearbox 32 is in particular positioned in such a way that the center axis 56 of the respective drive shaft 34 lies in the central operating point with as small an angle as possible, in particular concentrically, with respect to the wheel hub axle 58.

The drive device 16 described is configured in such a way that it can be employed both at the front axle 24 and at the rear axle 28 in accordance with the principle of identical parts. In particular, the drive machines 30 are configured in such a way that they can be arranged in front of or behind the respective associated vehicle axle—the front axle 24 or the rear axle 28—in the vehicle longitudinal direction x. The drive machines 30 of a common drive device 16 are housed in a common housing 42 with a common cooling circuit 44, in particular a common water circuit.

The gearbox 32 comprises a gearing unit for each drive machine 30. The gearing unit here comprises either the bevel gear 46, if the gearbox 32 does not comprise a planetary gear 52, or both the bevel gear 46 and the planetary gear 52 for the respective drive machine 30. In particular, the two gearing units of the gearbox 32 can share an oil supply.

By virtue of the described particularly compact configuration of the respective drive devices 16, storage blocks 14 of the traction battery 12 can be arranged between the respective drive device 16 and the passenger compartment in the vehicle longitudinal direction x. A main storage block 14 of the traction battery 12 is arranged below the passenger compartment and is split in two, as a result of which the energy tunnel 22 is formed. A storage block 14 arranged in the front region can be provided for supplying electrical energy to the drive device 16 associated with the front axle 24. A storage block 14, arranged in the rear region, of the traction battery 12 can be designed in such a way that it supplies electrical energy for the drive device 16 which is designed to drive the wheels 26 of the rear axle 28. Alternatively, the storage block 14 arranged in the front region and the storage block 14 arranged in the rear region can be connected together in such a way that they together supply electrical energy for one of the drive devices 16.

Overall, the invention shows how an improved drive architecture for an electric vehicle, which can also be referred to as a battery electric vehicle, can be obtained.

### LIST OF REFERENCE SIGNS

10 motor vehicle
12 traction battery
14 storage block
16 drive device
18 underbody
20 vehicle seat
22 energy tunnel
24 front axle
26 wheel
28 rear axle
30 drive machine
32 gearbox
34 drive axle
36 stator
38 axis of rotation
40 rotor
42 housing
44 cooling circuit
46 bevel gear
48 bevel pinion
50 master gear
52 planetary gear
54 inverter
56 center axis
58 wheel hub axle
60 wheel hub
x vehicle longitudinal direction
y vehicle transverse direction
z vehicle vertical direction

1.-10. (canceled)

11. A motor vehicle, comprising:
a drive device comprising at least one electric drive machine for driving wheels of the motor vehicle,
wherein a rotor of the drive machine has an axis of rotation oriented at least partially in a vehicle longitudinal direction, and
wherein the drive device is arranged on a vehicle center axis running in the vehicle longitudinal direction; and
a gearbox which is adjacent to the drive device in the vehicle longitudinal direction and is arranged between the wheels of a common axle in a vehicle transverse direction.

12. The motor vehicle according to claim 11, wherein
the drive device rests on an underbody of the motor vehicle.

13. The motor vehicle according to claim 11, wherein
the drive device comprises an electric drive machine for each of the wheels to be driven via the drive device.

14. The motor vehicle according to claim 11, wherein
the gearbox comprises a single-stage bevel gear for each drive machine of the drive device.

15. The motor vehicle according to claim 14, wherein
the gearbox additionally comprises a planetary gear with a stationary ring gear for each drive machine of the drive device.

16. The motor vehicle according to claim 11, wherein,
when the drive device comprises only one electric drive machine by which two wheels of the motor vehicle are to be driven, the gearbox comprises a differential.

17. The motor vehicle according to claim 11, wherein
the gearbox is connected via a drive shaft to a wheel hub axle of a respective wheel to be driven in a torque-transmitting fashion, and
the drive shaft is arranged concentrically with the wheel hub axle in the vehicle transverse direction.

18. The motor vehicle according to claim 11, further comprising:
a traction battery which is arranged between a front axle and a rear axle of the motor vehicle in the vehicle longitudinal direction,
wherein the drive device comprises:
a first drive device for a front axle, by which wheels of the front axle are drivable, and
a second drive device for a rear axle, by which wheels of the rear axle are drivable.

19. The motor vehicle according to claim 18, wherein
the traction battery has at least one recess and at least one of the first and second drive devices projects into the at least one recess.

20. The motor vehicle according to claim 18, wherein
the traction battery is divided into a plurality of storage blocks, and
a control device is provided which is configured to regulate from which of the plurality storage blocks electrical energy is supplied for which drive device.
